(19) United States
(12) Patent Application Publication
(10) Pub. No.: US 2022/0224049 A1
(43) Pub. Date: Jul. 14, 2022

(54) WIRE HARNESS

(71) Applicant: Yazaki Corporation, Tokyo (JP)

(72) Inventors: Ryo Akasaka, Shizuoka (JP); Takeshi Kamata, Shizuoka (JP)

(21) Appl. No.: 17/569,454

(22) Filed: Jan. 5, 2022

(30) Foreign Application Priority Data
Jan. 8, 2021 (JP) 2021-001762

(51) Int. Cl. H01R 13/635; B60R 16/02; H01B 11/02; H01R 13/512

(52) U.S. Cl. CPC H01R 13/635; H01R 13/512; H01B 11/02; B60R 16/0207

(57) ABSTRACT

Provided are an electric wire including: a core wire in which twisted wires having element wires are twisted in a same twisting direction as that in each of the twisted wires; and a connector. The connector includes: a terminal metal fitting having a terminal connection part fitted and connected to a mating terminal connection part in the fitting connection direction, and an electric wire connection part connected to a core wire exposed part; and a housing that draws out the electric wire from a storage chamber in the intersecting direction. The terminal of the electric wire includes a bent part in which a coated terminal part is bent with the core wire. The electric wire is formed such that a returning force becomes smaller than an absolute value of a spring force.

### CROSS-REFERENCE TO RELATED APPLICATION(S)

The present application claims priority to and incorporates by reference the entire contents of Japanese Patent Application No. 2021-001762 filed in Japan on Jan. 8, 2021.

### BACKGROUND OF THE INVENTION

### 1. Field of the Invention

The present invention relates to a wire harness.

### 2. Description of the Related Art

Conventionally, a wire harness configured as an electric wire with a connector in which a connector is assembled to a terminal of an electric wire has been known. In the wire harness, the connector is fitted and connected to a terminal block or a mating connector. Consequently, a terminal metal fitting is fitted and connected to a mating terminal metal fitting such as a terminal block. In the connector, the terminal metal fitting is electrically connected to the terminal of the electric wire in a housing, and the electric wire is drawn out to the outside of the housing. As the connector, a connector in which the fitting connection direction and the electric wire drawing direction are intersected with each other has been known. For example, such a wire harness is disclosed in Japanese Patent Application Laid-open No. 2014-107152 and Japanese Patent Application Laid-open No. 2016-192359.

For example, in a conventional wire harness, the fitting connection direction and the electric wire drawing direction are intersected with each other, by interposing a flexible relay conductor between the electric wire and the terminal metal fitting, and by distributing dividing the terminal metal fitting and the electric wire into the fitting connection direction and the electric wire drawing direction using the relay conductor. Consequently, in the wire harness, not only the cost for the relay conductor itself, but also man-hour and cost for assembling the relay conductor to the electric wire and the terminal metal fitting are required.

Note that Japanese Patent Application Laid-open No. 2005-251608 discloses an electric wire including a core wire having a plurality of twisted wires obtained by twisting a plurality of element wires, and in which the twisted wires that wrap a center twisted wire in the peripheral direction are twisted in the same twisting direction as that of the center twisted wire. In the electric wire, to prevent the element wires in the center twisted wire from being untwisted, the twisting direction of each of the wires is in the same direction. Moreover, Japanese Patent Application Laid-open No. 2005-259583 discloses an electric wire including a core wire having a plurality of twisted wires obtained by twisting a plurality of element wires in the same twisting direction, in which the twisted wires in an intermediate layer that wrap the center twisted wire in the peripheral direction are twisted in the opposite direction from the twisting direction of the twisted wires, and in which the twisted wires in an outer layer that wrap the twisted wires in the intermediate layer in the peripheral direction are twisted in the opposite direction from the twisting direction of the twisted wires. In the electric wire, a structure in which the wires are twisted in such a twisting direction is adopted to increase the flexibility of the core wire.

### SUMMARY OF THE INVENTION

An object of the present invention is to provide a wire harness in which the fitting connection direction and the electric wire drawing direction are intersected with each other while reducing the number of components.

In order to achieve the above mentioned object, a wire harness according to one aspect of the present invention includes an electric wire including a core wire including a plurality of twisted wires obtained by twisting a plurality of element wires, the twisted wires having the element wires twisted in a same twisting direction, the twisted wires being twisted in a same twisting direction as the twisting direction in each of the twisted wires, and a coating that wraps the core wire while exposing a core wire exposed part at a terminal of the electric wire; and a connector assembled to the terminal of the electric wire, wherein the connector includes a terminal metal fitting having a terminal connection part configured to be fitted and connected to a mating terminal connection part in a fitting connection direction, and configured to maintain a connected state between contact points by a spring force acts between the mating terminal connection part and the terminal connection part, and an electric wire connection part physically and electrically connected to the core wire exposed part an axial direction of which is in the fitting connection direction, and an insulating housing that stores the terminal of the electric wire and the terminal metal fitting in a storage chamber inside, and that draws out the electric wire to outside from a drawing port of the storage chamber, in an intersecting direction with respect to the fitting connection direction, the terminal of the electric wire includes a bent part in which a coated terminal part of the coating after being drawn out from the electric wire connection part is bent with the core wire, and the terminal of the electric wire is drawn out to outside of the housing from the drawing port over the bent part, and the electric wire is formed such that a returning force to a shape before being bent according to a bending shape of the bent part becomes smaller than an absolute value of the spring force.

According to another aspect of the present invention, in the wire harness, it is preferable that the electric wire is formed such that when an applied load obtained by supplying an allowable external input to the connector is applied to the core wire exposed part, the returning force becomes equal to or less than an absolute value of a subtraction value of the spring force and the applied load.

According to still another aspect of the present invention, in the wire harness, it is preferable that the electric wire includes the coating having flexibility capable of generating the returning force with the core wire.

According to still another aspect of the present invention, in the wire harness, it is preferable that the core wire includes a center twisted wire formed of one piece of the twisted wires placed in a center, an intermediate layer in which the twisted wires are arranged around an axis of the center twisted wire around the center twisted wire, and are twisted in the same twisting direction as the twisting direction in each of the twisted wires, and an outer layer in which the twisted wires are arranged around the axis of the center twisted wire around the intermediate layer, and are twisted in the same twisting direction as the twisting direction in each of the twisted wires.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a wire harness of an embodiment;

FIG. 2 is a perspective view of the wire harness of the embodiment when viewed from a shield shell side;

FIG. 3 is a sectional view cut along a line X-X in FIG. 1;

FIG. 4 is an exploded perspective view of the wire harness of the embodiment that is partially disassembled;

FIG. 5 is a perspective view for explaining an electric wire;

FIG. 6 is a plan view for explaining a twisting direction of a core wire of the electric wire;

FIG. 7 is an exploded perspective view illustrating a terminal metal fitting and a spring contact point member;

FIG. 8 is an exploded perspective view of a housing;

FIG. 9 is an exploded perspective view of the housing when viewed from another angle; and

FIG. 10 is a diagram illustrating test results of the returning force of electric wires.

### DETAILED DESCRIPTION OF THE PREFERRED EMBODIMENTS

Hereinafter, an embodiment of a wire harness according to the present invention will be described in detail with reference to the accompanying drawings. It is to be noted that the invention is not limited to the embodiment.

### Embodiment

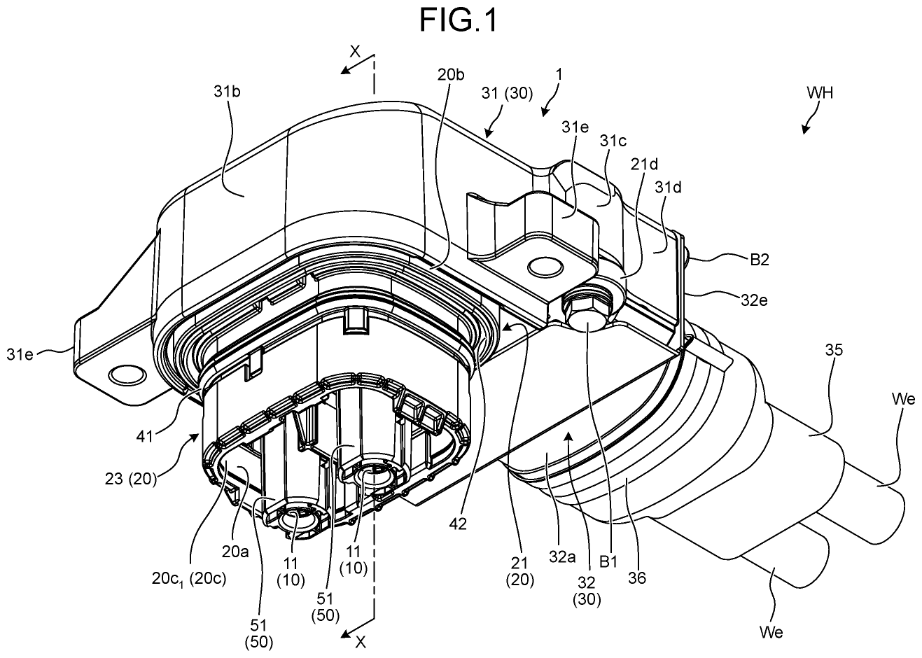

An embodiment of a wire harness according to the present invention will be described with reference to FIG. 1 to FIG. 10.

A reference numeral WH in FIG. 1 to FIG. 4 indicates a wire harness of the present embodiment. The wire harness WH is what is called an electric wire with a connector, and includes an electric wire We and a connector 1 assembled to a terminal of the electric wire We. The wire harness WH illustrated in this example includes the connector 1 with a plurality of poles, and has the number of electric wires We according to the number of poles. In this example, the wire harness WH includes two electric wires We and the connector 1 with two poles.

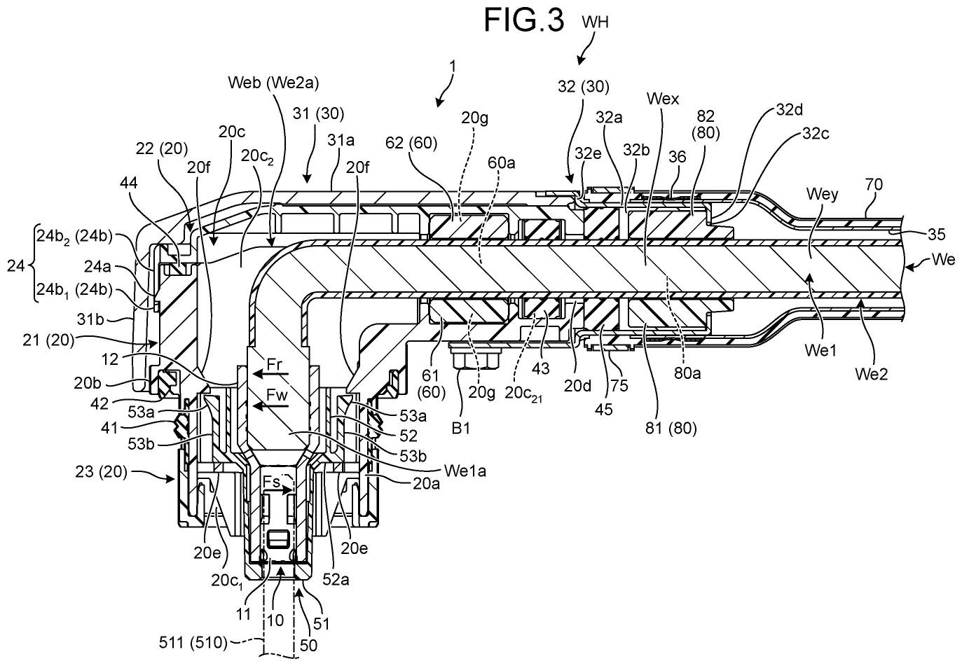

The connector 1 is electrically connected to a mating terminal metal fitting 510 (FIG. 3), when the connector 1 is inserted into and fitted to a mating fitting part (not illustrated) from a tip end. For example, the connector 1 illustrated in this example is configured such that a fitting part 20a of a housing 20, which will be described below, is inserted into and fitted to the inside of a hole-shaped mating fitting part having an inner peripheral wall surface. In the connector 1, the fitting part 20a is inserted into and removed from the hole-shaped mating fitting part in a hole axis direction of the mating fitting part. For example, the mating fitting part is formed such that an orthogonal cross section of the mating fitting part with respect to the hole axis direction is formed in a rectangular shape. The mating fitting part may also be formed in a tubular shape, and the fitting part 20a may be inserted into and fitted to the inner space of the tubular-shaped mating fitting part.

For example, by being electrically connected to the mating terminal metal fitting 510 of a mating device (not illustrated), the connector 1 electrically connects between the mating device and a device (not illustrated) at the tip of the electric wire We. The mating device includes a metal casing, and a through hole formed on a wall body of the casing is used as a mating fitting part. Moreover, the mating device includes a terminal block or a mating connector in the casing. The mating terminal metal fitting 510 is provided in the terminal block or the mating connector. Thus, in the connector 1, the fitting part 20a is inserted into and fitted to the inside of the mating fitting part, and is electrically connected to the mating terminal metal fitting 510 of the terminal block or the mating connector in the casing.

Hereinafter, when simply referred to as an insertion direction, the insertion direction refers to an insertion direction of the fitting part 20a of the connector 1 with respect to the mating fitting part. Moreover, when simply referred to as a removal direction, the removal direction refers to a removal direction of the fitting part 20a of the connector 1 with respect to the mating fitting part. Furthermore, when simply referred to as an insertion/removal direction, the insertion/removal direction refers to an insertion/removal direction of the fitting part 20a of the connector 1 with respect to the mating fitting part.

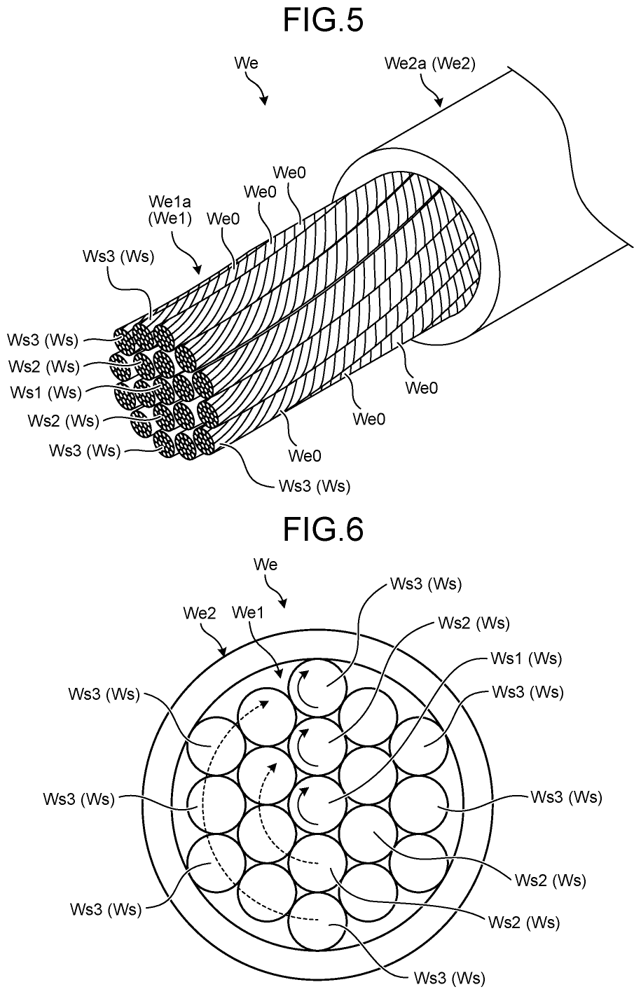

The electric wire We includes a core wire We1 serving as a conductor, and coating We2 that wraps the core wire We1 while a core wire exposed part We1a of the terminal is exposed (FIG. 3, FIG. 5, and FIG. 6). In the electric wire We, by peeling off the coating We2 of the terminal, the core wire exposed part We1a inside the coating We2 is exposed.

The core wire We1 includes a plurality of twisted wires Ws obtained by twisting a plurality of element wires We0 (FIG. 5). In the core wire We1, the twisted wires Ws including the element wires We0 twisted in the same twisting direction, are twisted in the same twisting direction as that in each of the twisted wires Ws (FIG. 5 and FIG. 6). The core wire We1 illustrated in this example includes a center twisted wire Ws1 formed of one piece of the twisted wire Ws placed in the center; an intermediate layer Ws2 in which the twisted wires Ws are arranged around the axis of the center twisted wire Ws1 around the center twisted wire Ws1, and are twisted in the same twisting direction as that in each of the twisted wires Ws; and an outer layer Ws3 in which the twisted wires Ws are arranged around the axis of the center twisted wire Ws1 around the intermediate layer Ws2, and are twisted in the same twisting direction as that in each of the twisted wires Ws (FIG. 5 and FIG. 6). A solid line arrow in FIG. 6 illustrates the twisting direction of the element wires We0 in the twisted wire Ws. However, in the present drawing, illustration of the element wires We0 is omitted. Moreover, a broken line arrow in FIG. 6 illustrates the twisting direction of each of the twisted wire Ws in the intermediate layer Ws2, and the twisting direction of each of the twisted wires Ws in the outer layer Ws3.

The coating We2 is formed to have flexibility capable of generating a returning force Fr, which will be described below, with the core wire We1. This point will be described below.

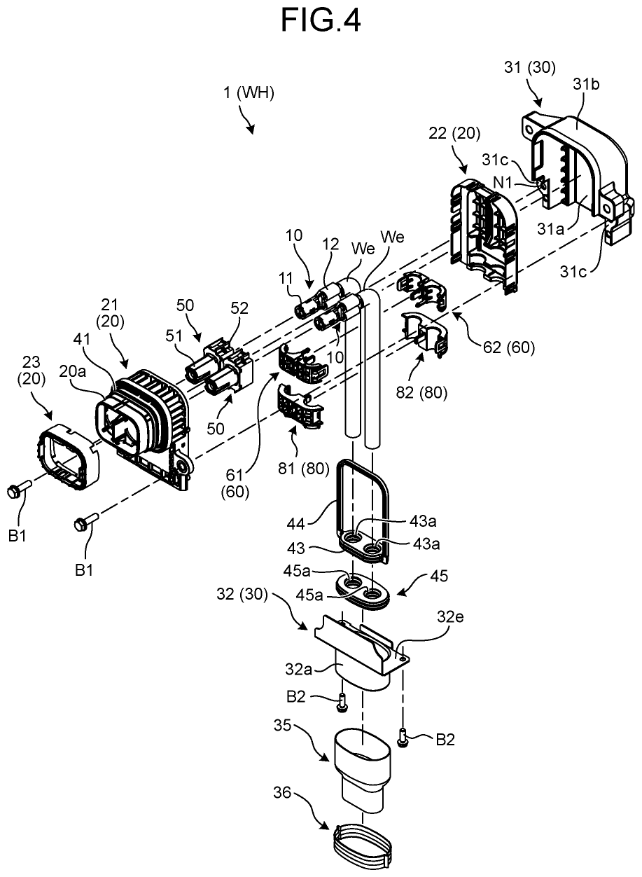

The connector 1 includes a terminal metal fitting 10, an insulating housing 20 that stores the electric wire We and the terminal metal fitting 10, and a conductive shield shell 30 for reducing noise, as connector components (FIG. 1, FIG. 3, and FIG. 4).

The terminal metal fitting 10 is formed of a conductive material such as metal. For example, the terminal metal fitting 10 is formed into a predetermined shape by performing press molding such as bending and cutting on a metal plate serving as a base material.

The terminal metal fitting 10 includes a terminal connection part 11 physically and electrically connected to a mating terminal connection part 511 of the mating terminal metal fitting 510 (FIG. 1, FIG. 3, and FIG. 4). The terminal connection part 11 is physically and electrically connected to the mating terminal connection part 511, when the terminal connection part 11 is fitted and connected to the mating terminal connection part 511 in the fitting connection direction. Moreover, in the terminal connection part 11, the connected state between the contact points is maintained by a spring force Fs (FIG. 3) acts between the mating terminal connection part 511 and the terminal connection part 11. One of the terminal connection part 11 and the mating terminal connection part 511 is formed in a female terminal shape, and the other of the terminal connection part 11 and the mating terminal connection part 511 is formed in a male terminal shape. The terminal connection part 11 and the mating terminal connection part 511 are then fitted and connected to each other by inserting and fitting between the fitting part 20a and the mating fitting part. The size and direction of the spring force Fs illustrated in FIG. 3 are merely for convenience of explanation.

Hereinafter, when simply referred to as a fitting connection direction, the fitting connection direction refers to a fitting connection direction of the terminal connection part 11 with respect to the mating terminal connection part 511 and a fitting connection direction of the fitting part 20a with respect to the mating fitting part (that is, the insertion direction described above).

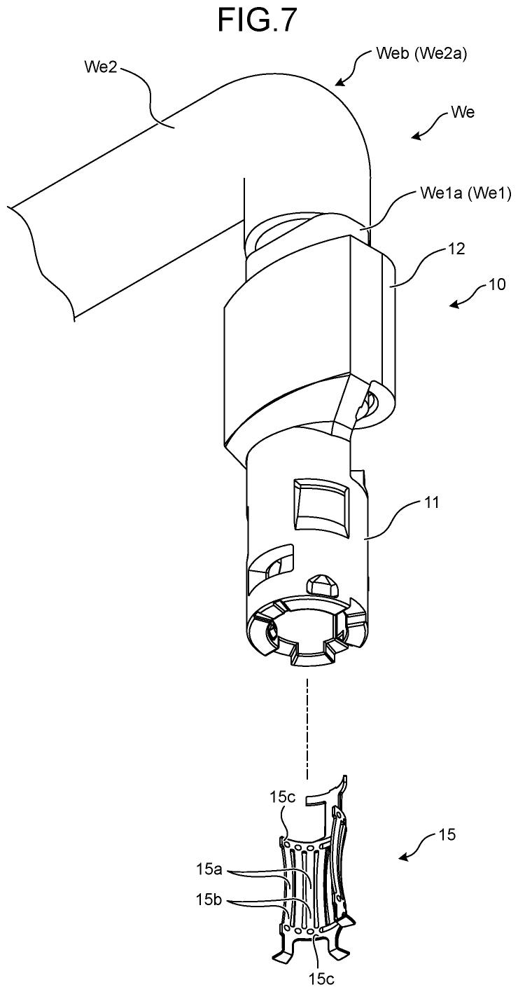

The spring force Fs is generated on the female terminal side. For example, when the terminal connection part 11 is formed in a tubular female terminal shape, the terminal metal fitting may have a spring contact point, and a spring contact point member may be assembled in the tube as another component. In this example, the terminal connection part 11 is formed in a cylindrical-shaped female terminal shape, and a spring contact point member 15 is assembled in the terminal connection part 11 (FIG. 7).

In the terminal metal fitting 10, a tube axis direction of the terminal connection part 11 is the insertion/removal direction. The mating terminal connection part 511 is formed in a shaft-like male terminal shape to be fitted into the terminal connection part 11.

The spring contact point member 15 includes a contact point part 15a that comes into contact with a contact point part of the mating terminal connection part 511, and a spring part 15b that is elastically deformable between the terminal connection part 11 and the mating terminal connection part 511, and that maintains the connected state between the contact point part 15a and the contact point part of the mating terminal connection part 511 by the spring force Fs caused by the elastic deformation (FIG. 7). In the spring contact point member 15 illustrated in this example, two arc-shaped base parts 15c are disposed in the tube axis direction of the terminal connection part 11 with a gap interposed therebetween, and the two arc-shaped base parts 15c are coupled by a plurality of the spring parts 15b. Each of the spring parts 15b is formed in a convex arc shape curving on the tube axis side inside the terminal connection part 11. In the spring contact point member 15, the arc-shaped vertex of the spring part 15b is used as the contact point part 15a. Thus, in the spring contact point member 15, when the mating terminal connection part 511 is fitted into the terminal connection part 11, the spring part 15b in which force is applied to the contact point part 15a by the mating terminal connection part 511, is elastically deformed toward the inner peripheral surface side of the terminal connection part 11. Consequently, the spring force Fs is applied in the orthogonal direction with respect to the fitting connection direction.

Moreover, the terminal metal fitting 10 includes an electric wire connection part 12 physically and electrically connected to the core wire exposed part We1a (FIG. 3 and FIG. 4). The electric wire connection part 12 is physically and electrically connected to the core wire exposed part We1a the axial direction of which is in the fitting connection direction. For example, the electric wire connection part 12 is physically and electrically connected to the core wire exposed part We1a, by being crimped or welded to the core wire exposed part We1a. In the electric wire connection part 12 illustrated in this example, two barrel pieces are caulked and crimped to the core wire exposed part We1a. The electric wire We is drawn out from the electric wire connection part 12 in the opposite direction from the fitting connection direction (that is, the removal direction).

In this manner, the terminal metal fitting 10 is formed in a straight shape such that the tube axis direction (fitting connection direction) of the terminal connection part 11 and the drawing direction of the electric wire We from the electric wire connection part 12 (hereinafter, referred to as an “electric wire drawing direction) are in the same direction. In the connector 1, the straight-shaped terminal metal fitting 10, and the terminal of the electric wire We that is bent after being drawn out from the electric wire connection part 12, are stored in the housing 20 (FIG. 3 and FIG. 4). Then, in the connector 1, the electric wire We is drawn out to the outside of the housing 20 (FIG. 3) at a portion over the bending point. The terminal of the electric wire We includes a bent part Web in which a coated terminal part We2a of the coating We2 after being drawn out from the electric wire connection part 12 is bent with the core wire We1 (FIG. 3 and FIG. 5).

The connector 1 includes a plurality of sets of combinations of the terminal metal fitting 10 and the electric wire We to be a pair. In this example, there are two sets of combinations (FIG. 4). In the connector 1, the two terminal metal fittings 10 are disposed side by side in the orthogonal direction with respect to the fitting connection direction. Moreover, in the connector 1, the two electric wires We are made to run in parallel and arranged in the orthogonal direction.

The housing 20 is formed of an insulating material such as synthetic resin.

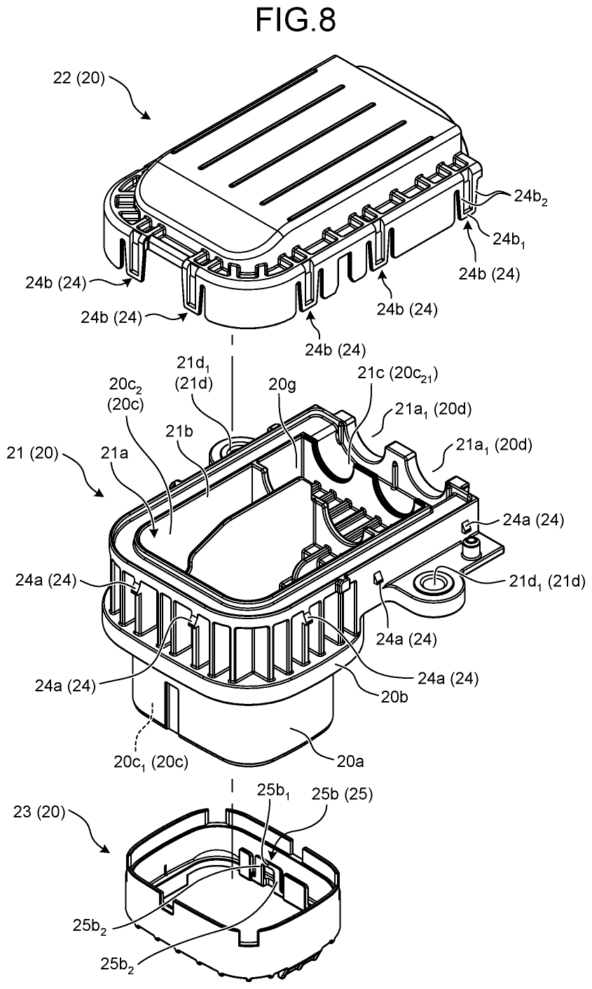

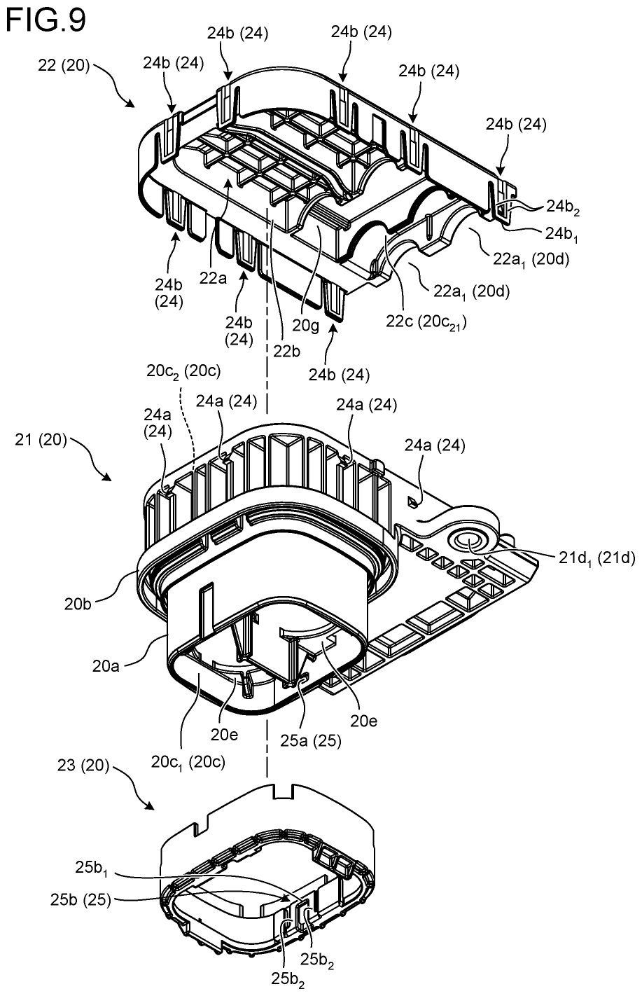

This housing 20 includes the fitting part 20a to be inserted into and fitted to the mating fitting part (FIG. 1 to FIG. 4, FIG. 8, and FIG. 9). The fitting part 20a illustrated in this example is inserted into and fitted to the inside of the hole-shaped mating fitting part in the insertion direction, and is pulled out from the inside of the mating fitting part in the removal direction, which is the opposite direction from the insertion direction. The fitting part 20a is formed in a tubular shape such that the tube axis direction thereof is the insertion/removal direction (insertion direction and removal direction) of the fitting part 20a with respect to the mating fitting part. The fitting part 20a illustrated in this example is formed in a rectangular tube shape.

As a connector component, the connector 1 includes an annular seal member 41 for water proofing and dust proofing between the fitting part 20a and the mating fitting part, by filling an annular gap therebetween (FIG. 1 to FIG. 4). The seal member 41 is formed of an elastic member such as synthetic rubber. The seal member 41 is then assembled to the outer peripheral surface of the fitting part 20a.

Moreover, the housing 20 includes a collar-shaped flange part 20b on the outside of the outer peripheral surface of the fitting part 20a (FIG. 1, FIG. 3, FIG. 8, and FIG. 9). When the fitting part 20a and the mating fitting part are in a fitting completed state, the flange part 20b has an opposite wall surface disposed opposite to a wall surface on the periphery of the mating fitting part with a gap interposed therebetween. As a connector component, the connector 1 includes an annular seal member 42 (FIG. 1 and FIG. 3) for water proofing and dust proofing between the opposite wall surface of the flange part 20b and the wall surface on the periphery of the mating fitting part, by filling a gap therebetween. The seal member 42 is formed of an elastic member such as synthetic rubber. The seal member 42 is fitted into an annular groove formed on the opposite wall surface of the flange part 20b in a protruding manner.

In the housing 20, the terminal metal fitting 10 is stored inside the fitting part 20a.

The housing 20 includes a storage chamber 20c that stores the terminal of the electric wire We and the terminal metal fitting 10 inside, and a drawing port 20d through which the electric wire We is drawn out to the outside from the storage chamber 20c in the intersecting direction with respect to the fitting connection direction (FIG. 3, FIG. 8, and FIG. 9). That is, the housing 20 stores the terminal of the electric wire We and the terminal metal fitting 10 in the storage chamber 20c inside, and draws out the electric wire We to the outside from the drawing port 20d of the storage chamber 20c in the intersecting direction with respect to the fitting connection direction. As described above, in the terminal of the electric wire We, the coated terminal part We2a is bent with the core wire We1. Consequently, the bent tip of the terminal of the electric wire We is drawn out to the outside of the housing 20 from the drawing port 20d.

The storage chamber 20c includes a terminal storage part 20c₁ that stores the terminal metal fitting 10, and an electric wire storage part 20₂ that stores the terminal of the electric wire We drawn out from the electric wire connection part 12 of the terminal metal fitting 10 (FIG. 3, FIG. 8, and FIG. 9). In the housing 20, space inside the tubular fitting part 20a is used as the terminal storage part 20c₁. For example, the terminal storage part 20c₁ is divided into a plurality of chambers for each terminal metal fitting 10 with a partition wall and the like. Moreover, the electric wire storage part 20c₂ is formed such that the terminal of the electric wire We is stored while the terminal of the electric wire We is made to run in the intersecting direction with respect to the fitting connection direction. For example, the electric wire storage part 20c₂ is divided into a plurality of chambers for each electric wire We with a partition wall and the like.

In the housing 20 illustrated in this example, the terminal of the electric wire We that is bent at a right angle after being drawn out from the electric wire connection part 12 of the straight-shaped terminal metal fitting 10 is stored in the electric wire storage part 20c₂. The electric wire We is then drawn out to the outside from the drawing port 20d in the orthogonal direction with respect to the fitting connection direction. Consequently, the electric wire storage part 20c₂ is formed in a shape capable of storing the terminal of the electric wire We while the terminal of the electric wire We is made to run in the orthogonal direction with respect to the fitting connection direction, and capable of drawing out the electric wire We to the outside from the drawing port 20d as it is.

As a connector component, the connector 1 includes a terminal holding member 50 stored in the terminal storage part 20c₁ of the storage chamber 20c, and that holds the terminal metal fitting 10 in the terminal storage part 20c₁ (FIG. 1 to FIG. 4). The terminal holding member 50 is formed of an insulating material such as synthetic resin. The terminal holding member 50 stores and holds the terminal metal fitting 10 inside such that the mating terminal connection part 511 can be inserted into and removed from the terminal metal fitting 10. The terminal holding member 50 is also held by the inner peripheral surface of the fitting part 20a.

The terminal holding member 50 may also be provided for each terminal metal fitting 10, or may also be provided as one component capable of holding a plurality of the terminal metal fittings 10. The terminal holding member 50 illustrated in this example is provided for each terminal metal fitting 10.

The terminal holding member 50 includes a cylindrical-shaped first tubular part 51 that stores the terminal connection part 11, and a rectangular tube-shaped second tubular part 52 that stores the electric wire connection part 12 (FIG. 3 and FIG. 4). The size of the second tubular part 52 is larger than the first tubular part 51 such that the second tubular part 52 is bulged outward in the radial direction.

The terminal holding member 50 is inserted into the storage chamber 20c toward the insertion direction side, stored in the terminal storage part 20c₁, and is held by the terminal storage part 20c₁. The housing 20 includes a first engagement part 20e (FIG. 3 and FIG. 9) that is disposed on the insertion direction side of the terminal holding member 50 in the terminal storage part 20c₁, and that engages the relative movement of the terminal holding member 50 toward the insertion direction side. The housing 20 also includes a second engagement part 20f (FIG. 3) that is disposed on the removal direction side of the terminal holding member 50 in the terminal storage part 20c₁, and that engages the relative movement of the terminal holding member 50 toward the removal direction side.

The first engagement part 20e is disposed opposite to the second tubular part 52 of the terminal holding member 50 on the insertion direction side. In this example, the outer wall surface on the insertion direction side of the second tubular part 52 serves as a first part to be engaged 52a. By engaging the first part to be engaged 52a with the first engagement part 20e, the terminal holding member 50 is prevented from coming out from the terminal storage part 20c₁ toward the insertion direction side (FIG. 3). The first tubular part 51 projects from the first part to be engaged 52a. The first engagement part 20e illustrated in this example is formed as a wall body projecting from the inner peripheral surface of the fitting part 20a. The first engagement part 20e illustrated in this example may also be used to engage the first part to be engaged 52a of each terminal holding member 50, or may be provided for each terminal holding member 50. Moreover, the first engagement part 20e illustrated in this example is provided on a housing main body 21, which will be described below, including the fitting part 20a.

The second engagement part 20f is disposed opposite to a second part to be engaged 53a of the terminal holding member 50 on the removal direction side (FIG. 3). In this example, a lock mechanism that allows the terminal holding member 50 to be inserted into the terminal storage part 20c₁, and that prevents the terminal holding member 50 from coming out from the terminal storage part 20c₁ toward the removal direction side, is provided between the fitting part 20a of the housing 20 and the terminal holding member 50. The lock mechanism includes the claw-shaped second engagement part 20f projecting from the inner peripheral surface of the fitting part 20a; the claw-shaped second part to be engaged 53a that is provided on the terminal holding member 50 and that is disposed opposite to the second engagement part 20f on the removal direction side, at the storage completed position of the terminal holding member 50 in the terminal storage part 20c₁; and a cantilevered flexible piece part 53b having flexibility in which the second part to be engaged 53a is at the free end, and the fixed end is provided on the second tubular part 52 of the terminal holding member 50 (FIG. 3). The flexible piece part 53b is elastically deformable such that when the terminal holding member 50 is inserted into the terminal storage part 20c₁, the second part to be engaged 53a can climb over the second engagement part 20f, and after the second part to be engaged 53a has climbed over the second engagement part 20f, the second engagement part 20f and the second part to be engaged 53a can be disposed opposite to each other in the insertion/removal direction. Consequently, with the terminal holding member 50, by using the lock mechanism, the terminal holding member 50 can be inserted into the terminal storage part 20c₁, and after the terminal holding member 50 is inserted into the terminal storage part 20c₁, the terminal holding member 50 is prevented from coming out from the terminal storage part 20c₁ toward the removal direction side.

In the connector 1, the first engagement part 20e is provided for each terminal holding member 50, and two sets of pairs of the second engagement part 20f and the second part to be engaged 53a are provided.

Moreover, as a connector component, the connector 1 includes a seal member (hereinafter, referred to as a “terminal side seal member”) 43 for water proofing and dust proofing between the inner peripheral wall of the storage chamber 20c and the electric wire We, by filling a gap therebetween (FIG. 3 and FIG. 4). The terminal side seal member 43 is formed of an elastic member such as synthetic rubber.

The terminal side seal member 43 may be provided for each electric wire We, and may also fill a gap between the inner peripheral wall of the storage chamber 20c and a plurality of the electric wires We. The terminal side seal member 43 illustrated in this example fills a gap between the inner peripheral wall of the electric wire storage part 20c₂ in the storage chamber 20c and the two electric wires We.

Furthermore, in this example, the electric wire storage part 20c₂ includes a space part 20c₂₁ formed in an oval shape, and the terminal side seal member 43 is disposed in the space part 20c₂₁ (FIG. 3, FIG. 8, and FIG. 9). Thus, the terminal side seal member 43 illustrated in this example is formed in an oval shape, and includes a circular through hole 43a for each electric wire We (FIG. 4). Then, in the terminal side seal member 43, an annular lip (hereinafter, referred to as an “outer peripheral lip”) is formed on the outer peripheral surface in a coaxial manner, and an annular lip (hereinafter, referred to as an “inner peripheral lip”) is formed on the inner peripheral surface of the through hole 43a in a coaxial manner. The terminal side seal member 43 brings the outer peripheral lip into close contact with the inner peripheral wall of the oval space part 20c₂₁ in the electric wire storage part 20c₂ and brings the inner peripheral lip into close contact with the outer peripheral surface of the electric wire We.

Furthermore, the connector 1 includes an electric wire holding tool (hereinafter, referred to as a “first electric wire holding tool”) 60 that holds the electric wire We in the storage chamber 20c as a connector component (FIG. 3 and FIG. 4). The first electric wire holding tool 60 is formed of an insulating material such as synthetic resin. The first electric wire holding tool 60 may also be provided for each electric wire We, or may be provided as one component capable of holding the electric wires We. The first electric wire holding tool 60 illustrated in this example is provided as one component capable of holding the electric wires We (in this example, two electric wires We). Moreover, the first electric wire holding tool 60 illustrated in this example holds the electric wire We that is bent after being drawn out from the electric wire connection part 12 of the terminal metal fitting 10, in the electric wire storage part 20c₂ of the storage chamber 20c. The first electric wire holding tool 60 includes a column-shaped electric wire insertion part 60a through which the column-shaped electric wire We is inserted and that holds the electric wire We (FIG. 3).

The first electric wire holding tool 60 illustrated in this example includes a first electric wire holding member 61 and a second electric wire holding member 62 that hold the electric wire We therebetween (FIG. 3 and FIG. 4). The first electric wire holding member 61 and the second electric wire holding member 62 hold the electric wire We therebetween while the first electric wire holding member 61 and the second electric wire holding member 62 are assembled to each other. Thus, the first electric wire holding tool 60 includes a lock mechanism (for example, a lock mechanism using claw parts or the like to be hooked to each other) that maintains the assembled state of the first electric wire holding member 61 and the second electric wire holding member 62 therebetween.

The housing 20 includes a holding part 20g that holds the first electric wire holding tool 60 (FIG. 3, FIG. 8, and FIG. 9). At least one holding part 20g is provided in the housing 20. Moreover, the first electric wire holding tool 60 is placed closer to the terminal metal fitting 10 than the terminal side seal member 43 is (FIG. 3).

More specifically, the housing 20 illustrated in this example includes a housing main body 21, a cover member 22, and a front holder 23 (FIG. 3, FIG. 4, FIG. 8, and FIG. 9).

The housing main body 21 includes a first space part 21a that stores the terminal of the electric wire We and the terminal metal fitting 10, and a first opening part 21b through which the terminal of the electric wire We and the terminal metal fitting 10 are inserted into the first space part 21a (FIG. 8). For example, the first space part 21a is divided into a plurality of chambers for each combination of the electric wire We and the terminal metal fitting 10 with the partition wall and the like illustrated above. Moreover, in the housing main body 21, a semi-circular opening 21a₁ through which the electric wire We is drawn out from the first space part 21a is formed (FIG. 8). The opening 21a₁ is provided for each electric wire We. Moreover, in the housing main body 21, a first seal storage part 21c that stores the terminal side seal member 43 is provided (FIG. 8). Furthermore, in the housing main body 21, the fitting part 20a, the flange part 20b, the first engagement part 20e, and the second engagement part 20f described above are formed (FIG. 8 and FIG. 9).

The cover member 22 includes a second space part 22a that stores the terminal of the electric wire We and the terminal metal fitting 10, and a second opening part 22b through which the terminal of the electric wire We and the terminal metal fitting 10 are inserted into the second space part 22a (FIG. 9). For example, the second space part 22a is divided into a plurality of chambers for each electric wire We with the partition wall and the like described above. Moreover, in the cover member 22, a semi-circular opening 22a₁ through which the electric wire We is drawn out from the second space part 22a is formed (FIG. 9). The opening 22a₁ is provided for each electric wire We. Furthermore, in the cover member 22, a second seal storage part 22c that stores the terminal side seal member 43 is provided (FIG. 9).

In the housing 20, when the housing main body 21 and the cover member 22 are assembled to each other, the first opening part 21b and the second opening part 22b are fitted to each other, and the storage chamber 20c made of the first space part 21a and the second space part 22a is formed. Moreover, in the housing 20, when the housing main body 21 and the cover member 22 are assembled to each other, the drawing port 20d made of the openings 21a, and 22a₁ is formed. Furthermore, in the housing 20, when the housing main body 21 and the cover member 22 are assembled to each other, the space part 20c₂₁ of the electric wire storage part 20c₂ made of the first seal storage part 21c and the second seal storage part 22c is formed.

In the housing 20, the holding part 20g for the first electric wire holding tool 60 is provided on at least one of the housing main body 21 and the cover member 22. In this example, the holding part 20g is provided on the housing main body 21 and the cover member 22 (FIG. 3, FIG. 8, and FIG. 9). The holding part 20g of the housing main body 21 is a space part in which the first electric wire holding member 61 is stored, and holds the first electric wire holding member 61 by suppressing the relative movement of the first electric wire holding member 61 in the space part. The holding part 20g in the housing main body 21 illustrated in this example is formed as a chamber capable of surrounding the outer wall of the first electric wire holding member 61 without blocking a space part 65. The holding part 20g of the cover member 22 is a space part in which the second electric wire holding member 62 is stored, and holds the second electric wire holding member 62 by suppressing the relative movement of the second electric wire holding member 62 in the space part. The holding part 20g of the cover member 22 illustrated in this example is formed as a chamber capable of surrounding the outer wall of the second electric wire holding member 62 without blocking the space part 65.

The housing 20 also includes a lock mechanism (hereinafter, referred to as a “cover lock mechanism”) 24 that maintains the assembled state of the housing main body 21 and the cover member 22 that are assembled to each other (FIG. 3, FIG. 8, and FIG. 9). In the housing 20, a plurality of the cover lock mechanisms 24 are provided on each outer peripheral wall between the housing main body 21 and the cover member 22.

Each of the cover lock mechanisms 24 includes a first engagement body 24a provided on the housing main body 21, and a second engagement body 24b that is provided on the cover member 22, and that, when the housing main body 21 and the cover member 22 are in an assembled state, engages the movement in the reverse direction with respect to the assembly direction of the housing main body 21 and the cover member 22, between the first engagement body 24a and the second engagement body 24b (FIG. 3, FIG. 8, and FIG. 9).

The first engagement body 24a is formed as a claw-shaped projection body projecting from the outer peripheral wall of the housing main body 21 (FIG. 3, FIG. 8, and FIG. 9). On the other hand, the second engagement body 24b includes a piece-shaped second engagement part 24b₁ that, when the housing main body 21 and the cover member 22 are in an assembled state, engages the movement in the reverse direction with respect to the assembly direction of the housing main body 21 and the cover member 22, between the claw-shaped first engagement body 24a and the second engagement part 24b₁. The second engagement body 24b also includes two cantilever flexible piece parts 24b₂ having flexibility, in which the end part of the second engagement part 24b₁ is coupled at the free end side, and the fixed end is provided on the cover member 22 (FIG. 3, FIG. 8, and FIG. 9). Each of the flexible piece parts 24b₂ is elastically deformable such that, when the housing main body 21 and the cover member 22 are assembled to each other, the second engagement part 24b₁ can climb over the first engagement body 24a, and after the second engagement part 24b₁ has climbed over the first engagement body 24a, the first engagement body 24a and the second engagement part 24b₁ can be disposed opposite to each other.

Moreover, as a connector component, the housing 20 includes a seal member (hereinafter, referred to as a “cover seal member”) 44 for water proofing and dust proofing between the assembled housing main body 21 and the cover member 22 such that water and dust do not enter therebetween (FIG. 3 and FIG. 4). The cover seal member 44 is formed of an elastic member such as synthetic rubber. The cover seal member 44 illustrated in this example is formed in a rectangular annular shape, and is held between the housing main body 21 and the cover member 22. In the connector 1, the cover seal member 44 and the terminal side seal member 43 described above are formed as one integral component (FIG. 4).

The front holder 23 is formed in a rectangular tube shape that wraps the outer peripheral surface of the fitting part 20a of the housing main body 21, and is fitted to the fitting part 20a. The housing 20 includes a lock mechanism (hereinafter, referred to as a “holder lock mechanism”) 25 that maintains the assembled state of the housing main body 21 and the front holder 23 that are assembled to each other (FIG. 8 and FIG. 9). In the housing 20, a plurality of the holder lock mechanisms 25 are provided between the inner peripheral surface of the fitting part 20a and the front holder 23.

Each of the holder lock mechanism 25 includes a first engagement body 25a provided on the inner peripheral surface of the fitting part 20a of the housing main body 21, and a second engagement body 25b that is provided on the front holder 23 in a state that the second engagement body 25b is disposed opposite to the inner peripheral surface of the fitting part 20a, and that, when the fitting part 20a and the front holder 23 are in an assembled state, engages the movement in the reverse direction with respect to the assembly direction of the fitting part 20a and the front holder 23, between the first engagement body 25a and the second engagement body 25b (FIG. 8 and FIG. 9).

The first engagement body 25a is formed as a claw-shaped projection body projecting from the inner peripheral surface of the fitting part 20a (FIG. 9). On the other hand, the second engagement body 25b includes a piece-shaped second engagement part 25b₁ that, when the fitting part 20a and the front holder 23 are in an assembled state, engages the movement in the reverse direction with respect to the assembly direction of the fitting part 20a and the front holder 23, between the claw-shaped first engagement body 25a and the second engagement part 25b₁. The second engagement body 25b also includes two cantilevered flexible piece parts 25b₂ having flexibility in which the end part of the second engagement part 25b₁ is coupled at the free end side, and the fixed end is provided on the front holder 23 (FIG. 8 and FIG. 9). Each of the flexible piece parts 25b₂ is elastically deformable such that, when the fitting part 20a and the front holder 23 are assembled to each other, the second engagement part 25b₁ can climb over the first engagement body 25a, and after the second engagement part 25b₁ has climbed over the first engagement body 25a, the first engagement body 25a and the second engagement part 25b₁ can be disposed opposite to each other.

In the connector 1, the terminal of the electric wire We is bent and stored in the storage chamber 20c of the housing 20. Thus, on the terminal of the electric wire We, returning force Fr to the shape before being bent is generated according to the bending shape of the bent part Web (FIG. 3). In the connector 1, the returning force Fr is transmitted to the terminal metal fitting 10. For example, in the connector 1, the electric wire We is held by the terminal side seal member 43 and the first electric wire holding tool 60 at a side opposite to the terminal metal fitting 10 side when viewed from the bent part Web. Consequently, the entire returning force Fr generated on the terminal of the electric wire We is transmitted to the terminal metal fitting 10. Then, in the connector 1, the returning force Fr is transmitted to the surrounding connector components (housing 20, terminal holding member 50, and the like) via the terminal metal fitting 10. In general, in the connector 1, the connector components each have a dimensional tolerance, and looseness between the connector components is allowed within a range of the dimensional tolerance. Consequently, in the connector 1, when the returning force Fr caused by the bending of the terminal of the electric wire We is greater than the spring force Fs between the terminal connection part 11 and the mating terminal connection part 511, load to be applied between the contact point part (contact point part 15a of the spring contact point member 15) of the terminal metal fitting 10 and the contact point part of the mating terminal connection part 511 may be reduced. The size and direction of the returning force Fr illustrated in FIG. 3 are merely for convenience of explanation.

Hence, the electric wire We used for the connector 1 is formed such that the returning force Fr to the shape before being bent according to the bending shape of the bent part Web is made smaller than the absolute value of the spring force Fs (Fr<|Fs|). Accordingly, in the wire harness WH, it is possible to apply the spring force of the difference (|Fs−Fr|) between the terminal connection part 11 and the mating terminal connection part 511. Consequently, in the wire harness WH, it is possible to suppress a change in the load to be applied between the contact point part (contact point part 15a of the spring contact point member 15) of the terminal metal fitting 10 and the contact point part of the mating terminal connection part 511. Hence, it is possible to ensure the quality of conduction between the contact points.

More specifically, by taking into account the looseness of the connector components, the electric wire We is formed such that when an applied load Fw, which is obtained when an allowable external input is supplied to the connector 1, is applied to the core wire exposed part We1a (FIG. 3), the returning force Fr becomes equal to or less than the absolute value of a subtraction value of the spring force Fs and the applied load Fw (Fr≤|Fs−Fw|). For example, the allowable external input is the maximum value required to design a vehicle, in the force supplied to the connector 1 from the outside by the road surface input or acceleration and deceleration when the vehicle is traveling. Moreover, the applied load Fw is force (load) applied to the core wire exposed part We1a, when the allowable external input is supplied to the connector 1 in a state when the looseness of the connector components is at the maximum (a state when the worst values of dimensional tolerances of the connector components are accumulated). Accordingly, in the wire harness WH, even if the applied load Fw due to the looseness of the connector components is applied to the electric wire We, it is possible to suppress a change in the load to be applied between the contact point part (contact point part 15a of the spring contact point member 15) of the terminal metal fitting 10 and the contact point part of the mating terminal connection part 511, and ensure the quality of conduction between the contact points. The size and direction of the applied load Fw illustrated in FIG. 3 are merely for convenience of explanation.

Moreover, in the wire harness WH, the electric wire We is formed such that the returning force Fr becomes smaller than the absolute value of the subtraction value of the spring force Fs and the applied load Fw. Hence, it is possible to apply the spring force of the difference (|Fs−Fr−Fw|) between the terminal connection part 11 and the mating terminal connection part 511. Consequently, in the wire harness WH, the vibration can be absorbed between the terminal connection part 11 and the mating terminal connection part 511 when an external input (vibration) is applied. Hence, it is possible to ensure the quality of conduction between the contact points, when an external input (vibration) is applied.

In this example, to create the returning force Fr as described above, the electric wire We uses the core wire We1 in which the twisted wires Ws including the element wires We0 twisted in the same twisting direction, are twisted in the same twisting direction as that in each of the twisted wires Ws. The strength of the core wire We1 becomes lower than a core wire that includes twisted wires Ws having the element wires We0 twisted in different direction from each other, or a core wire in which the twisting direction of the element wires We0 and the twisting direction of the twisted wires Ws are in the opposite directions. Consequently, it is possible to reduce the returning force caused by bending.

Furthermore, in the electric wire We, the coated terminal part We2a is bent with the core wire We1. Consequently, the electric wire We is formed to have flexibility capable of generating the returning force Fr with the structure of the core wire We1.

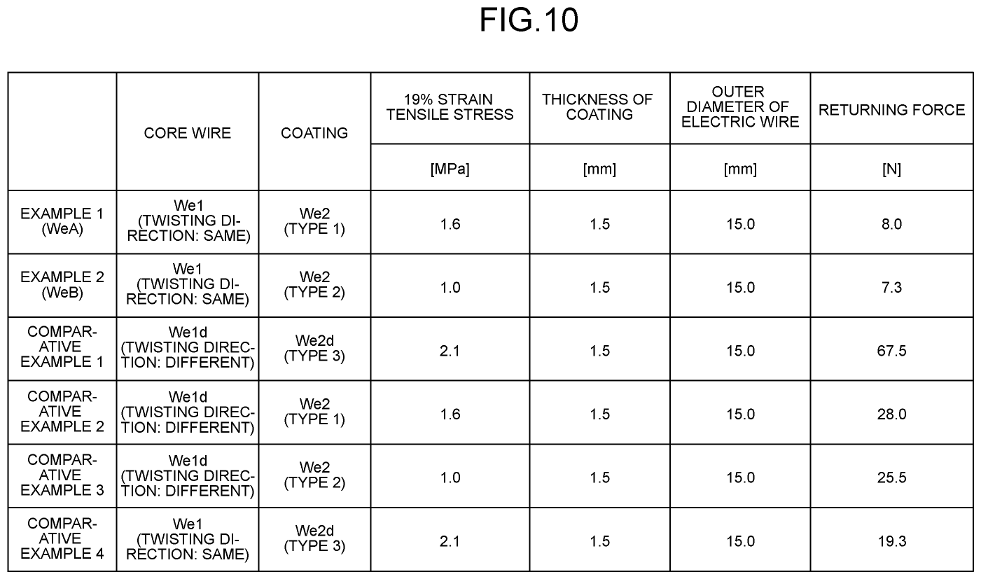

Hereinafter, comparison results of the returning force Fr of electric wires (an electric wire WeA in Example 1 and an electric wire WeB in Example 2) that fall under the category of the electric wire We in the present embodiment, and electric wires (Comparative Examples 1 to 4) that do not fall under the category of the electric wire We in the present embodiment will be described (FIG. 10). In all the electric wires, the thickness of coating (1.5 mm) and the outermost diameter (15.0 mm) are the same.

In the comparative tests of the returning force Fr, the connector 1 in which the spring force Fs is 22.4 N, and the applied load Fw according to the allowable external input when 7.1 G vibration is applied becomes 4.4 N is used. In the connector 1, the electric wire We the returning force Fr of which becomes 18.0 N (=|22.4−4.4|) or less is required. Then, in the comparative tests, load is applied to the tip end (terminal connection part 11) of the terminal metal fitting 10 from a state when the coated terminal part of the electric wire is bent at a right angle with the core wire, and the maximum value of the load is measured as the returning force Fr. The load is applied while the tip end of the terminal metal fitting 10 is pressed in at a predetermined movement amount per unit time.

The electric wire WeA in Example 1 is obtained by combining a type 1 coating We2 with the core wire We1 described above. Moreover, the electric wire WeB in Example 2 is obtained by combining a type 2 coating We2 with the core wire We1 described above, which is the same as that of the electric wire WeA in Example 1.

The core wire We1 illustrated in this example uses 19 pieces of the twisted wires Ws including 46 pieces of the element wires We0 with the diameter of 0.32 mm twisted in the same twisting direction at the same twisting pitch. In the core wire We1, one piece of the center twisted wire Ws1, the intermediate layer Ws2 formed of six pieces of the twisted wires Ws, and the outer layer Ws3 formed of 12 pieces of the twisted wires Ws are all twisted in the same direction.

The type 1 coating We2 contains 80 pts.wt. ethyl methacrylate (EMA) with a methacrylic acid (MA) content of 29%, 20 pts.wt. ethylene propylene diene rubber (EPDM), 40 pts.wt. flame retardant, 24 pts.wt. antioxidant, and 1 pt.wt. processing aid. The type 2 coating We2 contains 50 pts.wt. EMA with a MA content of 29-, 50 pts.wt. EPDM, 40 pts.wt. flame retardant, 24 pts.wt. antioxidant, and 1 pt.wt. processing aid. The type 2 coating We2 is more flexible than the type 1 coating We2. In the type 1 coating We2, 19% strain tensile stress on the test piece is 1.6 Mpa. In the type 2 coating We2, 19% strain tensile stress on the test piece is 1.0 Mpa.

The electric wire in Comparative Example 1 is obtained by combining a core wire Weld twisted in a different direction, with a type 3 coating We2d that does not fall under the category of the coating We2 of the present embodiment. The core wire Weld twisted in a different direction includes one piece of center twisted wire, an intermediate layer formed of six pieces of twisted wires, and an outer layer formed of 12 pieces of twisted wires. In the 13 pieces of twisted wires used for the center twisted wire and the outer layer, 46 pieces of the element wires We0 with the diameter of 0.32 mm are twisted in the same twisting direction at the same twisting pitch. On the other hand, in the six pieces of twisted wires used for the intermediate layer, 46 pieces of the element wires We0 with the diameter of 0.32 mm are twisted in the opposite twisting direction from that of the center twisted wire and the like, at the same twisting pitch as that of the center twisted wire and the like. Moreover, each of the twisted wires in the intermediate layer is twisted in the same twisting direction as that of the center twisted wire. On the other hand, each of the twisted wires in the outer layer is twisted in the opposite twisting direction from that of the center twisted wire. The type 3 coating We2d contains 100 pts.wt. EMA with a MA content of 29%, 40 pts.wt. flame retardant, 24 pts.wt. antioxidant, and 1 pt.wt. processing aid. In the coating We2d, 19% strain tensile stress on the test piece is 2.1 Mpa.

The electric wire in Comparative Example 2 is obtained by combining the core wire Weld twisted in a different direction, which is in the electric wire in Comparative Example 1, with the type 1 coating We2, which is the same as that of the electric wire WeA in Example 1. The electric wire in Comparative Example 3 is obtained by combining the core wire Weld twisted in a different direction, which is in the electric wire in Comparative Example 1, with the type 2 coating We2, which is the same as that of the electric wire WeB in Example 2. The electric wire in Comparative Example 4 is obtained by combining the core wire We1 (core wire We1 twisted in the same twisting direction), which is the same as that of the electric wire WeA in Example 1, with the type 3 coating We2d, which is the same as that of the electric wire in Comparative Example 1.

According to the comparison results in FIG. 10, in the electric wire WeA in Example 1 and the electric wire WeB in Example 2, each returning force Fr is 8.0 N and 7.3 N, and the returning force Fr is equal to or less than 18.0 N. On the other hand, in the electric wire in Comparative Example 1, the core wire and the coating do not fall under the category of the core wire We1 and the coating We2 in the present embodiment, and the returning force Fr is 67.5 N (>18.0 N). Moreover, in the electric wire in each Comparative Example 2 and Comparative Example 3, only the coating falls under the category of the coating We2 in the present embodiment, and each returning force Fr is 28.0 N (>18.0 N) and 25.5 N (>18.0 N). Furthermore, in the electric wire in Comparative Example 4, only the core wire falls under the category of the core wire We1 in the present embodiment, and the returning force Fr is 19.3 N (>18.0 N).

In this manner, in the electric wire We, if at least one of the core wire and the coating does not fall under the category of the present embodiment as Comparative Examples 1 to 4, the returning force Fr cannot be reduced to a desired value (18.0 N) or less. However, by using the core wire We1 and the coating We2 that fall under the category of the present embodiment as Examples 1 and 2, the returning force Fr can be reduced to a desired value (18.0 N) or less.

The connector 1 also includes the shield shell 30. The shield shell 30 covers the housing 20 to prevent external noise from penetrating inside, and to prevent noise from being applied to the electric wire We and the terminal metal fitting 10 in the housing 20. Thus, the shield shell 30 is formed of a conductive material such as metal.

The shield shell 30 includes a first shield shell member 31 and a second shield shell member 32 assembled to each other (FIG. 1 to FIG. 4).

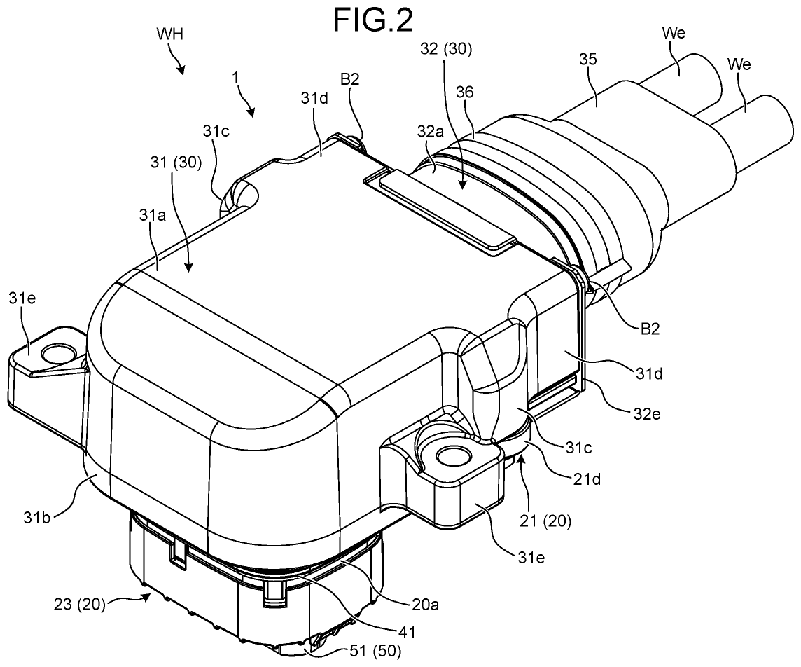

The first shield shell member 31 covers the housing 20 from the cover member 22 side so as to prevent noise from penetrating into the housing 20. The first shield shell member 31 illustrated in this example includes a main wall 31a that wraps the cover member 22, and a side wall 31b that surrounds the housing main body 21 while the drawing direction side of the electric wire is opened (FIG. 2 to FIG. 4).

The first shield shell member 31 is screw fixed to the housing main body 21 in a fastening structure in which the holding direction of the first electric wire holding tool 60 by the housing main body 21 and the cover member 22 is the screw axis direction. Two fixing parts 31c are provided on the side wall 31b of the first shield shell member 31 illustrated in this example, and a female screw part N1 is formed on each of the fixing parts 31c (FIG. 1, FIG. 2, and FIG. 4). Then, in the housing main body 21, a fixing part 21d to be fixed to the fixing part 31c is provided for each fixing part 31c (FIG. 1, FIG. 8, and FIG. 9), and a through hole 21d₁ (FIG. 8 and FIG. 9) for inserting a male screw member B1 (FIG. 1 and FIG. 4) is formed on each fixing part 21d. The first shield shell member 31 is screw fixed to the housing main body 21, by inserting the male screw member B1 into the through hole 21d₁, and by screwing the male screw member B1 into the female screw part N1.

The second shield shell member 32 prevents noise from penetrating into a first drawn out part Wex of the electric wire We that is a part drawn out from the storage chamber 20c. Hence, a tubular part 32a that stores the first drawn out part Wex is provided on the second shield shell member 32 (FIG. 1 to FIG. 4). The tubular part 32a illustrated in this example is formed in an oval tubular shape, and the inner space of the tubular part 32a is used as an electric wire storage chamber 32b that stores the first drawn out part Wex (FIG. 3). The second shield shell member 32 is assembled to the first shield shell member 31 in a state in which the end part is brought into surface contact with the first shield shell member 31. The second shield shell member 32 then stores the first drawn out part Wex in the electric wire storage chamber 32b inside the tubular part 32a placed closer to the drawing direction side of the electric wire than the end part of the second shield shell member 32 is, and draws out the electric wire We to the outside from a drawing port 32c of the electric wire storage chamber 32b (FIG. 3).

In the second shield shell member 32, a flat annular part 32d that is coaxial with the tubular part 32a and that projects inward, is provided on the periphery of the opening of the tubular part 32a on the drawing direction side of the electric wire (FIG. 3). In the second shield shell member 32, the opening of the annular part 32d on the inner peripheral surface side is used as the drawing port 32c of the electric wire We.

The second shield shell member 32 illustrated in this example includes a flat flange part 32e on the periphery of the opening of the tubular part 32a at the side opposite to the drawing port 32c (FIG. 1 to FIG. 4).

In this example, in the first shield shell member 31, two fixing parts 31d having a wall surface on the same flat surface as the end surface of the main wall 31a are provided on the side wall 31b (FIG. 1 and FIG. 2). Each of the fixing parts 31d is used for screw fixing the second shield shell member 32 to the first shield shell member 31 via the flange part 32e. Thus, the flat surface of the flange part 32e is brought into surface contact with the wall surface of the two fixing parts 31d. In this example, a female screw part (not illustrated) is formed on each of the fixing parts 31d. In the flange part 32e, a through hole (not illustrated) for inserting the male screw member B2 (FIG. 1 and FIG. 2) is formed for each fixing part 31d. By inserting the male screw member B2 into the through hole and screwing the male screw member B2 into the female screw part of the fixing part 31d, the second shield shell member 32 is screw fixed to the first shield shell member 31.

As a connector component, the connector 1 includes a conductive braided member 35 that is braided in a tubular shape, that covers the tubular part 32a of the second shield shell member 32 in a close contact state, and that wraps a second drawn out part Wey drawn out from the electric wire storage chamber 32b in the electric wire We (FIG. 1 to FIG. 4). As a connector component, the connector 1 also includes an annular seal ring 36 that caulks and crimps the braided member 35 by holding the braided member 35 between the outer peripheral wall of the tubular part 32a and the annular seal ring 36 (FIG. 1 to FIG. 4). For example, in the connector 1, the two fixing parts 31e (FIG. 1 and FIG. 2) provided on the side wall 31b of the first shield shell member 31 are screw fixed to the metal casing of the mating device, and noise is released by electrically connecting the shield shell 30 and the braided member 35 to the casing.

Moreover, as a connector component, the connector 1 includes a rubber boot 70 that is formed in a tubular shape, that covers the braided member 35 while covering the tubular part 32a of the second shield shell member 32 in a close contact state, and that stores the braided member 35 so as to wrap and hide the braided member 35 inside (FIG. 3). For example, the rubber boot 70 is fixed to the outer peripheral wall of the tubular part 32a in a close contact state, by winding a fastening member 75 such as a cable tie from the outside. Illustration of the rubber boot 70 is omitted in the drawings other than the present drawing.

Moreover, as a connector component, the connector 1 includes a seal member (hereinafter, referred to as a “braided side seal member”) 45 for water proofing and dust proofing between the inner peripheral wall of the electric wire storage chamber 32b and the first drawn out part Wex of the electric wire We, by filling a gap therebetween (FIG. 3 and FIG. 4). The braided side seal member 45 is formed of an elastic member such as synthetic rubber.

The braided side seal member 45 may be provided for each electric wire We, or may fill a gap between the inner peripheral wall of the electric wire storage chamber 32b and the first drawn out parts Wex of the electric wires We. The braided side seal member 45 illustrated in this example fills a gap between the inner peripheral wall of the electric wire storage chamber 32b and the first drawn out part Wex of each of the two electric wires We.

The braided side seal member 45 illustrated in this example is formed in an oval shape, and includes a circular through hole 45a for each electric wire We (FIG. 4). Then, in the braided side seal member 45, an annular lip (hereinafter, referred to as an “outer peripheral lip”) is formed on the outer peripheral surface in a coaxial manner, and an annular lip (hereinafter, referred to as an “inner peripheral lip”) is formed on the inner peripheral surface of the through hole 45a in a coaxial manner. In the braided side seal member 45, the outer peripheral lip is brought into close contact with the inner peripheral wall of the tubular part 32a, and the inner peripheral lip is brought into close contact with the outer peripheral surface of the first drawn out part Wex of the electric wire We.

Moreover, the connector 1 includes an electric wire holding tool (hereinafter, referred to as a “second electric wire holding tool”) 80 that holds the electric wire We in the electric wire storage chamber 32b of the second shield shell member 32 as a connector component (FIG. 3 and FIG. 4). The second electric wire holding tool 80 is formed of an insulating material such as synthetic resin. The second electric wire holding tool 80 may be provided for each electric wire We, or may be provided as one component capable of holding the electric wires We. The second electric wire holding tool 80 illustrated in this example is provided as one component capable of holding the first drawn part Wex of the electric wires We (in this example, two electric wires We). Moreover, similar to the first electric wire holding tool 60 described above, the second electric wire holding tool 80 illustrated in this example is obtained by assembling a first electric wire holding member 81 and a second electric wire holding member 82 formed as the same component (FIG. 3 and FIG. 4). The second electric wire holding tool 80 includes an electric wire insertion part 80a, which is the same as the electric wire insertion part 60a of the first electric wire holding tool 60. Moreover, similar to the first electric wire holding tool 60, the second electric wire holding tool 80 includes a lock mechanism (for example, a lock mechanism using claw parts or the like to be hooked to each other) that maintains the assembled state of the first electric wire holding member 81 and the second electric wire holding member 82 therebetween. In this example, the second electric wire holding tool 80 is placed closer to the drawing port 32c side of the electric wire storage chamber 32b than the braided side seal member 45 is (FIG. 3).

As described above, the wire harness WH of the present embodiment uses the electric wire We the returning force Fr of which to the shape before being bent according to the bending shape of the bent part Web becomes smaller than the absolute value of the spring force Fs between the terminal connection part 11 and the mating terminal connection part 511 (that is, the electric wire We with high flexibility). Hence, it is possible to apply the spring force of the difference (|Fs−Fr|) between the terminal connection part 11 and the mating terminal connection part 511. In particular, the wire harness WH illustrated in this example uses the electric wire We the returning force Fr of which becomes equal to or less than the absolute value of the subtraction value of the spring force Fs and the applied load Fw (that is, the electric wire We with higher flexibility). Hence, even if the looseness of the connector components is taken into account, it is possible to apply the spring force of the difference (|Fs−Fr−Fw|) between the terminal connection part 11 and the mating terminal connection part 511. Consequently, in the wire harness WH, because it is possible to suppress a change in the load to be applied between the contact point part (contact point part 15a of the spring contact point member 15) of the terminal metal fitting 10 and the contact point part of the mating terminal connection part 511, it is possible to ensure the quality of conduction between the contact points. The wire harness WH of the present embodiment can make the fitting connection direction and the electric wire drawing direction intersect with each other, while ensuring the quality of conduction, by bending the electric wire We without interposing a flexible relay conductor between the electric wire We and the terminal metal fitting 10. That is, the wire harness WH of the present embodiment can make the fitting connection direction and the electric wire drawing direction intersect with each other, while ensuring the quality of conduction and reducing the number of components.

Moreover, the wire harness WH of the present embodiment can be reduced in size and weight, by reducing the number of components.

Furthermore, in the wire harness WH of the present embodiment, there is no need to peel off the coating We2 of the bent part Web of the electric wire We. Hence, there is no need to take measures assuming that the peripheral component may come into contact with the core wire We1 of the bent part Web (measures such as increasing a gap between the peripheral component and the core wire We1, and coating the bare core wire We1 with resin). Thus, from this point also, the wire harness WH of the present embodiment can reduce the number of components, and can be reduced in size and weight. In the wire harness WH of the present embodiment, because the coating We2 can be left on the bent part Web, it is possible to improve the durability of the electric wire We in the bent part Web.

The wire harness according to the embodiment uses the electric wire the returning force of which to the shape before being bent according to the bending shape of the bent part is smaller than the absolute value of the spring force between the terminal connection part and the mating terminal connection part (that is, the electric wire with high flexibility). Hence, it is possible to apply the spring force of the difference of the returning force and the spring force between the terminal connection part and the mating terminal connection part. Consequently, in the wire harness, it is possible to suppress a change in the load to be applied between the contact point part of the terminal metal fitting and the contact point part of the mating terminal connection part, and ensure the quality of conduction between the contact points. The wire harness according to the embodiment can also make the fitting connection direction and the electric wire drawing direction intersect with each other while ensuring the quality of conduction, by bending the electric wire without interposing a flexible relay conductor between the electric wire and the terminal metal fitting. That is, the wire harness according to the embodiment can make the fitting connection direction and the electric wire drawing direction intersect with each other, while ensuring the quality of conduction and reducing the number of components.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness, comprising:
an electric wire including
a core wire including a plurality of twisted wires obtained by twisting a plurality of element wires, the twisted wires having the element wires twisted in a same twisting direction, the twisted wires being twisted in a same twisting direction as the twisting direction in each of the twisted wires, and
a coating that wraps the core wire while exposing a core wire exposed part at a terminal of the electric wire; and
a connector assembled to the terminal of the electric wire, wherein
the connector includes
a terminal metal fitting having
a terminal connection part configured to be fitted and connected to a mating terminal connection part in a fitting connection direction, and configured to maintain a connected state between contact points by a spring force acts between the mating terminal connection part and the terminal connection part, and
an electric wire connection part physically and electrically connected to the core wire exposed part an axial direction of which is in the fitting connection direction, and
an insulating housing that stores the terminal of the electric wire and the terminal metal fitting in a storage chamber inside, and that draws out the electric wire to outside from a drawing port of the storage chamber, in an intersecting direction with respect to the fitting connection direction,
the terminal of the electric wire includes a bent part in which a coated terminal part of the coating after being drawn out from the electric wire connection part is bent with the core wire, and the terminal of the electric wire is drawn out to outside of the housing from the drawing port over the bent part, and
the electric wire is formed such that a returning force to a shape before being bent according to a bending shape of the bent part becomes smaller than an absolute value of the spring force.

2. The wire harness according to claim 1, wherein
the electric wire is formed such that when an applied load obtained by supplying an allowable external input to the connector is applied to the core wire exposed part, the returning force becomes equal to or less than an absolute value of a subtraction value of the spring force and the applied load.

3. The wire harness according to claim 1, wherein
the electric wire includes the coating having flexibility capable of generating the returning force with the core wire.

4. The wire harness according to claim 2, wherein
the electric wire includes the coating having flexibility capable of generating the returning force with the core wire.

5. The wire harness according to claim 1, wherein
the core wire includes
a center twisted wire formed of one piece of the twisted wires placed in a center,
an intermediate layer in which the twisted wires are arranged around an axis of the center twisted wire around the center twisted wire, and are twisted in the same twisting direction as the twisting direction in each of the twisted wires, and
an outer layer in which the twisted wires are arranged around the axis of the center twisted wire around the intermediate layer, and are twisted in the same twisting direction as the twisting direction in each of the twisted wires.

6. The wire harness according to claim 2, wherein
the core wire includes
a center twisted wire formed of one piece of the twisted wires placed in a center,
an intermediate layer in which the twisted wires are arranged around an axis of the center twisted wire around the center twisted wire, and are twisted in the same twisting direction as the twisting direction in each of the twisted wires, and
an outer layer in which the twisted wires are arranged around the axis of the center twisted wire around the intermediate layer, and are twisted in the same twisting direction as the twisting direction in each of the twisted wires.

7. The wire harness according to claim 3, wherein
the core wire includes
a center twisted wire formed of one piece of the twisted wires placed in a center,
an intermediate layer in which the twisted wires are arranged around an axis of the center twisted wire around the center twisted wire, and are twisted in the same twisting direction as the twisting direction in each of the twisted wires, and
an outer layer in which the twisted wires are arranged around the axis of the center twisted wire around the intermediate layer, and are twisted in the same twisting direction as the twisting direction in each of the twisted wires.

8. The wire harness according to claim 4, wherein
the core wire includes
a center twisted wire formed of one piece of the twisted wires placed in a center,
an intermediate layer in which the twisted wires are arranged around an axis of the center twisted wire around the center twisted wire, and are twisted in the same twisting direction as the twisting direction in each of the twisted wires, and
an outer layer in which the twisted wires are arranged around the axis of the center twisted wire around the intermediate layer, and are twisted in the same twisting direction as the twisting direction in each of the twisted wires.
